(19) United States
(12) Patent Application Publication
(10) Pub. No.: US 2023/0312407 A1
(43) Pub. Date: Oct. 5, 2023

(54) Article Coated by a Multi-Layer Coating Stack

(71) Applicant: Vitro Flat Glass LLC, Cheswick, PA (US)

(72) Inventors: Farzad Fareed, San Diego, CA (US); Andrew V. Wagner, Pittsburgh, PA (US); Paul A. Medwick, Wexford, PA (US); Ashtosh Ganjoo, Allison Park, PA (US); Patrick Fisher, Pittsburgh, PA (US)

(21) Appl. No.: 18/128,579

(22) Filed: Mar. 30, 2023

Related U.S. Application Data
(60) Provisional application No. 63/405,147, filed on Sep. 9, 2022.
(60) Provisional application No. 63/325,870, filed on Mar. 31, 2022.

(51) Int. Cl. C03C 17/34; E06B 9/24

(52) U.S. Cl. CPC C03C 17/3435; E06B 9/24; C03C 17/3417; E06B 2009/2417; B60J 1/00

(57) ABSTRACT

An article coated by a multi-layer coating stack includes: the article; and the multi-layer coating stack including: a first layer including a metal oxide or a metal nitride arranged over the article; a functional layer including indium doped tin oxide arranged over the first layer; and a second layer including a silicon oxide arranged over the functional layer.

### BACKGROUND

### Field

The present disclosure is directed to an article coated by a multi-layer coating stack including, in some non-limiting embodiments, a transparency having the multi-layer coating stack on a surface thereof.

### Technical Considerations

Transparencies are included in vehicles and architectural structures to allow a user inside to see out (and vice versa) and to allow light to enter the inside of the vehicle or architectural structure. As a consequence of the sunlight being incident to the transparency, radiative heat transfer between the transparency and the interior of the vehicle or architectural structure can alter the temperature therein, which can be undesirable. Low emissivity coatings applied over transparencies have been developed to reduce the radiative heat transfer between the transparency and the inside. These low emissivity coatings are subject to environmental conditions and can significantly change in color and performance if the coating degrades. Therefore, a need exists to protect the low emissivity coatings.

### SUMMARY OF THE DISCLOSURE

According to some non-limiting aspects of the disclosure, an article coated by a multi-layer coating stack includes: the article; and the multi-layer coating stack including: a first layer including a metal oxide or a metal nitride arranged over the article; a functional layer including indium doped tin oxide arranged over the first layer; and a second layer including a silicon oxide arranged over the functional layer.

In some non-limiting aspects, the silicon oxide of the second layer may be a silicon aluminum oxide. The first layer may include: an underlayer arranged over the article, the underlayer including at least one of zinc oxide, tin oxide, zinc-tin oxide, zinc stannate, silicon nitride, or silicon aluminum nitride; and an overlayer arranged over the underlayer, the overlayer including a silicon oxide. The coated article may consist essentially of or consist of: the first layer arranged over the article, the first layer including: an underlayer arranged over the article, the underlayer including at least one of zinc oxide, tin oxide, zinc-tin oxide, zinc stannate, silicon nitride, or silicon aluminum nitride; and an overlayer arranged over the underlayer, the overlayer including a silicon oxide; the functional layer arranged over the first layer; and the second layer arranged over the functional layer, the second layer including a silicon oxide. The coated article may have the following structure: the first layer arranged directly over the article, the first layer including: an underlayer arranged directly over the article, the underlayer including at least one of zinc oxide, tin oxide, zinc-tin oxide, zinc stannate, silicon nitride, or silicon aluminum nitride; and an overlayer arranged directly over the underlayer, the overlayer including a silicon oxide; the functional layer arranged directly over the first layer; and the second layer arranged directly over the functional layer, the second layer including a silicon oxide.

In some non-limiting aspects, the coated article may further include a protective layer arranged over the second layer. The protective layer may include a metal oxynitride layer arranged over the second layer and a metal oxide layer arranged over the metal oxynitride layer, the metal oxide layer may be a titanium oxide, a zinc oxide, a zirconium oxide, a titanium aluminum oxide, a silicon aluminum oxide or a combination thereof. The coated article may consist essentially of or consist of: the first layer arranged over the article, the first layer including: an underlayer arranged over the article, the underlayer including at least one of zinc oxide, tin oxide, zinc-tin oxide, zinc stannate, silicon nitride, or silicon aluminum nitride; and an overlayer arranged over the underlayer, the overlayer including a silicon oxide; the functional layer arranged over the first layer; the second layer arranged over the functional layer, the second layer including a silicon oxide; and the protective layer arranged over the second layer, the protective layer including: a metal oxynitride layer arranged over the second layer; and a metal oxide layer arranged over the metal oxynitride layer, the metal oxide layer including at least one of a titanium oxide, a zinc oxide, a zirconium oxide, a titanium aluminum oxide, a silicon aluminum oxide, or a combination thereof. The coated article may have the following structure: the first layer arranged directly over the article, the first layer including: an underlayer arranged directly over the article, the underlayer including at least one of zinc oxide, tin oxide, zinc-tin oxide, zinc stannate, silicon nitride, or silicon aluminum nitride; and an overlayer arranged directly over the underlayer, the overlayer including a silicon oxide; the functional layer arranged directly over the first layer; the second layer arranged directly over the functional layer, the second layer including a silicon oxide; and the protective layer arranged directly over the second layer, the protective layer including: a metal oxynitride layer arranged directly over the second layer; and a metal oxide layer arranged directly over the metal oxynitride layer, the metal oxide layer including at least one of a titanium oxide, a zinc oxide, a zirconium oxide, a titanium aluminum oxide, a silicon aluminum oxide, or a combination thereof.

In some non-limiting aspects, the coated article may include glass or plastic. The functional layer may have a thickness of less than 160 nm. The second layer may be substantially free of alumina and a silicon aluminum oxynitride. In one embodiment, the second layer and/or the protective layer may have a thickness of less than 70 nm. In another embodiment, the second layer, the protective layer, and/or the combination thereof may have a thickness from 70-100 nm, such as from 75-97 nm, or from 80-95 nm. The second layer may be the outermost layer. The protective layer may be the outermost layer. The functional layer may be substantially free of silver. The coated article may be mounted in a body of a vehicle or an insulating glass unit.

According to some non-limiting aspects of the disclosure, a transparency includes the coated article, where the multi-layer coating stack is arranged on a surface of the transparency. The coated article includes: the article; and the multi-layer coating stack including: a first layer including a metal oxide or a metal nitride arranged over the article; a functional layer including indium doped tin oxide arranged over the first layer; and a second layer including a silicon oxide arranged over the functional layer.

In some non-limiting aspects, the transparency may include a vehicle window, where the multi-layer coating stack is arranged on an inside surface of the vehicle window. The transparency may include an insulating glass unit for an architectural structure. The insulating glass unit may include: a first transparency having a first surface and a second surface; and a second transparency having a third surface and a fourth surface, where a gap is defined between the second surface and the third surface, where the first surface is exposed to an outdoor side of the architectural structure and the fourth surface is exposed to an indoor side of the architectural structure, where the multi-layer coating stack is arranged on the fourth surface.

### BRIEF DESCRIPTION OF THE DRAWINGS

The disclosure will be described with reference to the following drawing figures wherein like reference numbers identify like parts throughout.

FIG. 1A shows a side view (not to scale) of an article coated by a multi-layer coating stack, according to some aspects of the disclosure.

FIG. 1B shows a side view (not to scale) of an article coated by a multi-layer coating stack, according to some aspects of the disclosure.

FIG. 10 shows a side view (not to scale) of an article coated by a multi-layer coating stack, according to some aspects of the disclosure.

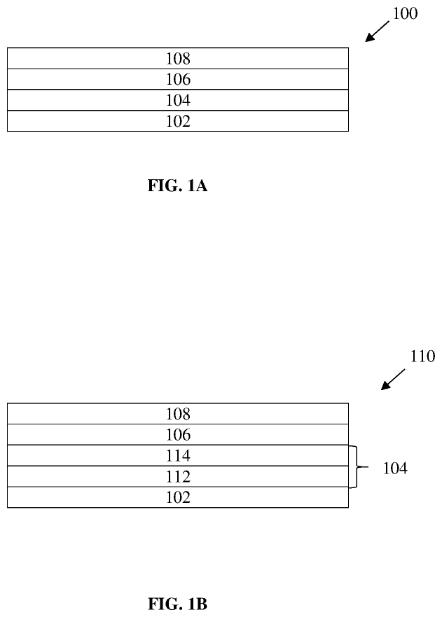

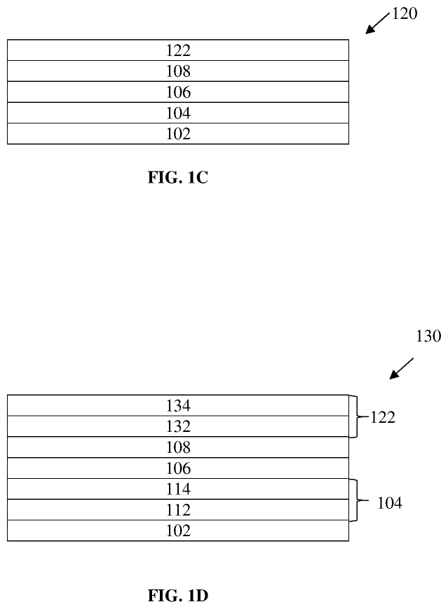

FIG. 1D shows a side view (not to scale) of an article coated by a multi-layer coating stack, according to some aspects of the disclosure.

FIG. 2 shows a sectional view (not to scale) of a multi-layer coating stack applied over a transparency mounted in a vehicle body.

FIG. 3 shows a sectional view (not to scale) of a multi-layer coating stack applied over a transparency in an insulating glass unit mounted in an architectural structure.

### DETAILED DESCRIPTION

As used herein, spatial or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present disclosure. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

Further, as used herein, the terms “formed over”, “deposited over”, “arranged over”, or “provided over” mean formed, deposited, arranged, or provided on but not necessarily in contact with the surface. For example, a coating layer “arranged over” a substrate does not preclude the presence of one or more other coating layers or films of the same or different composition located between the formed coating layer and the substrate.

As used herein, the term “film” refers to a coating region of a desired or selected coating composition. A “layer” can comprise one or more “films”, and a “coating” or “coating stack” can comprise one or more “layers”.

Additionally, all documents, such as, but not limited to, issued patents and patent applications, referred to herein are to be considered to be “incorporated by reference” in their entirety.

The present disclosure is directed to an article coated by a multi-layer coating stack, comprising: the article; and the multi-layer coating stack comprising: a first layer comprising a metal oxide or a metal nitride arranged over the article; a functional layer comprising indium doped tin oxide (ITO) arranged over the first layer; and a second layer comprising a silicon oxide arranged over the functional layer.

Referring to FIGS. 1A and 1B, non-limiting embodiments of a coated article 100, 110 according to the present disclosure are shown. The coated article 100, 110 comprises an article 102 over which a multi-layer coating stack is applied. The multi-layer coating stack is applied over a surface of the article 102. The multi-layer coating stack comprises a first layer 104 comprising a metal oxide or a metal nitride arranged over the article 102. The multi-layer coating stack comprises a functional layer 106 comprising indium doped tin oxide arranged over the first layer 104. The multi-layer coating stack comprises a second layer 108 comprising a silicon oxide arranged over the functional layer 106.

Non-limiting examples of suitable materials for the article 102 comprise glass or plastic. The article 102 may comprise a ceramic material.

Non-limiting examples of suitable plastic materials include acrylic polymers, such as polyacrylates; polyalkylmethacrylates, such as polymethylmethacrylates, polyethylmethacrylates, polypropylmethacrylates, and the like; polyurethanes; polycarbonates; polyalkylterephthalates, such as polyethyleneterephthalate (PET), polypropyleneterephthalates, polybutyleneterephthalates, and the like; polysiloxane-containing polymers; or copolymers of any monomers for preparing these, or any mixtures thereof.

Non-limiting examples of suitable glass materials include conventional soda-lime-silicate glass, borosilicate glass, or leaded glass. The glass can be clear glass. By “clear glass” is meant non-tinted or non-colored glass. Alternatively, the glass can be tinted or otherwise colored glass. The glass can be annealed or heat-treated glass. As used herein, the term “heat treated” means tempered or at least partially tempered. The glass can be of any type, such as conventional float glass, and can be of any composition having any optical properties, e.g., any value of visible transmission, ultraviolet transmission, infrared transmission, and/or total solar energy transmission. By “float glass” is meant glass formed by a conventional float process in which molten glass is deposited onto a molten metal bath and controllably cooled to form a float glass ribbon. Examples of float glass processes are disclosed in U.S. Pat. Nos. 4,466,562 and 4,671,155.

The article 102 may comprise, for example, clear float glass or can be tinted or colored glass. The article 102 can be of any desired dimensions, e.g., length, width, shape, or thickness. In one non-limiting embodiment in which the article is an automotive transparency, the article 102 may be 1-10 mm thick, such as 1-8 mm thick, such as 2-8 mm, such as 3-7 mm, such as 5-7 mm, such as 4-6 mm thick. In one non-limiting embodiment in which the article is an architectural transparency, the article 102 may be 1-30 mm thick, such as 2.5-25 mm thick, such as 2.5-10 mm.

With continued reference to FIGS. 1A and 1B, the multi-layer coating stack may be arranged over a surface of the article 102, and the multi-layer coating stack may comprise the first layer 104 comprising a metal oxide or a metal nitride arranged over the article 102. The first layer 104 can be a single film (FIG. 1A) or a multiple film (FIG. 1B) layer.

Referring to FIG. 1B, the first layer 104 may be a multiple film layer comprising an underlayer 112 arranged over the article 102 and an overlayer 114 arranged over the underlayer 112. The underlayer 112 may comprise at least one of zinc oxide, tin oxide, zinc-tin oxide, zinc stannate, silicon nitride, silicon aluminum nitride, or mixtures thereof.

The zinc oxide or tin oxide may encompass a “zinc/tin alloy oxide”, by which is meant both true alloys and mixtures of the oxides. Zinc oxide can be deposited from a zinc cathode that includes other materials to improve the sputtering characteristics of the cathode. As such, the zinc/tin alloy oxide can be obtained from magnetron sputtering vacuum deposition from a cathode of zinc and tin. For example, the zinc cathode can include a small amount (e.g., up to 20 weight %, up to 15 weight %, up to 10 weight %, or up to 5 weight %) of tin to improve sputtering. In which case, the resultant zinc oxide film would include a small percentage of tin oxide, e.g., up to 10 weight % tin oxide, e.g., up to 5 weight % tin oxide. A coating layer deposited from a zinc cathode having up to 10 weight % tin (added to enhance the conductivity of the cathode) is referred to herein as “a zinc oxide film” even though a small amount of tin may be present. One non-limiting cathode can comprise zinc and tin in proportions of from 5 weight % to 95 weight % zinc and from 95 weight % to 5 weight % tin, such as from 10 weight % to 90 weight % zinc and from 90 weight % to 10 weight % tin. However, other ratios of zinc to tin could also be used.

By “zinc stannate” is meant a composition of ZnₓSn₁₋ₓO₂₋ₓ (Formula 1) where “x” varies in the range of greater than 0 to less than 1. For instance, “x” can be greater than 0 and can be any fraction or decimal between greater than 0 to less than 1. For example, where x=2/3, Formula 1 is Zn_{2/3}Sn_{1/3}O_{4/3}, which is more commonly described as “Zn₂SnO₄”. A zinc stannate-containing film has one or more of the forms of Formula 1 in a predominant amount in the layer.

The overlayer 114 may comprise a silicon oxide, defined as a compound comprising both silicon and oxygen. The silicon oxide may comprise, for example, silicon oxide, silicon aluminum oxide, silicon oxynitride, silicon aluminum oxynitride, or any mixtures thereof. The silicon oxide may comprise a silicon metal oxide, such as silicon aluminum oxide.

The first layer 104 may have a thickness of less than 70 nm, such as less than 50 nm. The first layer 104 may have a thickness of from 20-70 nm, such as from 30-50 nm.

In non-limiting embodiments in which the first layer comprises the underlayer 112 and the overlayer 114, the underlayer 112 may have a thickness of less than 30 nm, such as less than 20 nm, and the overlayer 114 may have a thickness of less than 50 nm, such as less than 40 nm. The underlayer 112 may have a thickness of from 10 nm to 30 nm, such as from 10 nm to 20 nm. The overlayer 114 may have a thickness of from 20 nm to 50 nm, such as from 20 nm to 40 nm. Alternatively, the first layer may consist of the underlayer 112 and the overlayer 114.

With continued reference to FIGS. 1A and 1B, the multi-layer coating stack may comprise the functional layer 106 arranged over the first layer 104. The functional layer 106 may comprise indium doped tin oxide. Alternatively, the functional layer may consist of indium doped tin oxide. The functional layer 106 may be in direct contact with the first layer 104.

The functional layer 106 may have a thickness of less than 160 nm, such as less than 150 nm, less than 120 nm, or less than 110 nm. For embodiments in which the coated article 100, 110 is a transparency mounted in a vehicle, the functional layer may have a thickness of from 55-110 nm, such as from 60-100 nm, or from 70-90 nm. For embodiments in which the coated article 100, 110 is a transparency in an insulating glass unit mounted in an architectural structure, the functional layer may have a thickness of from 100-160 nm, such as from 110-150 nm, or from 120-140 nm.

The functional layer 106 may be substantially free of a silver-containing compound. “Substantially free” of silver means the functional layer 106 contains less than 1 weight % of silver, or that silver is not intentionally added to the functional layer 106. The functional layer 106 may be free of a silver-containing compound, containing 0 weight % of a silver-containing compound.

With continued reference to FIGS. 1A and 1B, the multi-layer coating stack may comprise the second layer 108 arranged over the functional layer 106. The second layer 108 may comprise a silicon oxide. The silicon oxide may comprise silicon oxide, silicon aluminum oxide, silicon oxynitride, silicon aluminum oxynitride. The silicon oxide may comprise a silicon metal oxide, such as silicon aluminum oxide.

The second layer 108 may have a thickness of less than 70 nm, such as less than 60 nm, such as less than 55 nm, or less than 40 nm. The second layer 108 may have a thickness of from 10-70 nm, such as from 20-60 nm or from 30-55 nm. The second layer 108 may provide protection to the functional layer 106.

Alternatively, the second layer 108 may have a thickness of from 70-100 nm, from 72-95 nm, or from 80-95 nm. Such thicker second layers (compared to the less than 70 nm range described above) may exhibit improved antireflective properties. The second layer 108 may have a thickness of up to 100 nm or up to 95 nm.

The second layer 108 may be substantially free of alumina or a silicon aluminum oxynitride. “Substantially free” of alumina means the second layer 108 contains less than 5 weight % of alumina, or that alumina is not intentionally added to the layer. “Substantially free” of aluminum oxynitride means the second layer 108 contains less than 5 weight % of aluminum oxynitride or that aluminum oxynitride is not intentionally added to the layer. The second layer 108 may be free of alumina and/or aluminum oxynitride, containing 0 weight % of alumina and/or aluminum oxynitride.

As shown in FIGS. 1A and 1B, the second layer 108 may be the outermost layer on the coated article 100, 110, such that no coating layer is arranged thereover.

Referring to FIG. 1B, the coated article 110 may consist essentially of or consist of: the first layer 104 arranged over the article 102, the first layer 104 comprising: an underlayer 112 arranged over the article 102, the underlayer 112 comprising at least one of zinc oxide, tin oxide, zinc-tin oxide, zinc stannate, silicon nitride, or silicon aluminum nitride; and an overlayer 114 arranged over the underlayer 112, the overlayer 114 comprising a silicon oxide; the functional layer 106 arranged over the first layer 104; and the second layer 108 arranged over the functional layer 106, the second layer 108 comprising a silicon oxide.

Referring to FIG. 1B, the coated article 110 may have a layered structure in which the first layer 104 is arranged directly over the article 102, the first layer 104 comprising: an underlayer 112 arranged directly over the article 102, the underlayer 112 comprising at least one of zinc oxide, tin oxide, zinc-tin oxide, zinc stannate, silicon nitride, or silicon aluminum nitride; and an overlayer 114 arranged directly over the underlayer 112, the overlayer 114 comprising a silicon oxide; the functional layer 106 is arranged directly over the first layer 104; and the second layer 108 arranged directly over the functional layer 106, the second layer 108 comprising a silicon oxide. As used herein, a first layer described as being arranged “directly over” a second layer refers to the first layer being over and in direct contact with at least a portion of the second layer, without any intervening layers between the first layer and second layer at the portion in direct contact.

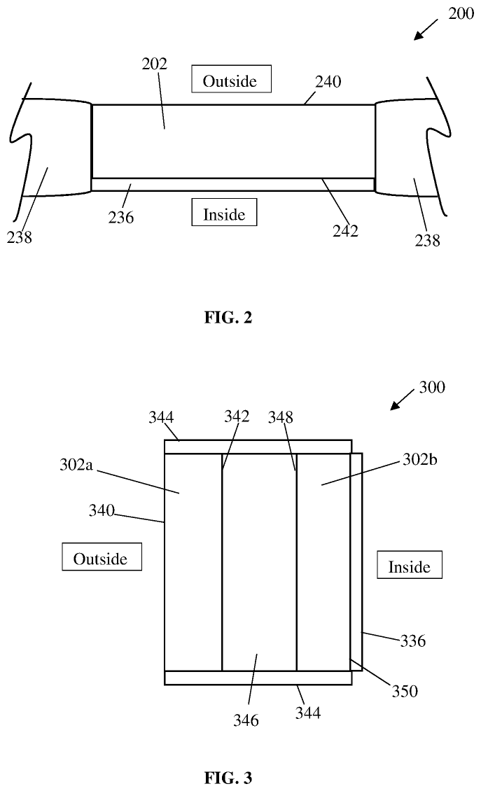

Referring to FIGS. 10 and 1D, the coated article 120, 130 may further comprise a protective layer 122 arranged over the second layer 108. It will be appreciated that the components bearing the same element numbers from the coated articles 120, 130 in FIGS. 10 and 1D have the same characteristics as those described in connection with the coated articles 100, 110 in FIGS. 1A and 1B.

The protective layer 122 can be a single film (FIG. 1C) or a multiple film (FIG. 1D) layer.

Referring to FIG. 1D, the protective layer 122 may be a multiple film layer comprising a metal oxynitride layer 132 arranged over the second layer 108 and a metal oxide layer 134 arranged over the metal oxynitride layer 132.

The metal oxynitride layer 132 comprises a metal oxynitride, defined as a compound comprising a metal, oxygen, and nitrogen. Non-limiting examples of metal oxynitride include silicon oxynitride and silicon aluminum oxynitride, or any mixtures thereof. The metal oxynitride layer 132 may comprise silicon aluminum oxynitride.

The metal oxynitride layer 132 may have a thickness of less than 50 nm, such as less than 40 nm. The metal oxynitride layer 132 may have a thickness of from 10-50 nm, such as from 20-40 nm.

The metal oxide layer 134 may comprise a metal oxide, defined as a compound comprising a metal and oxygen. Non-limiting examples of metal oxide include at least one of a titanium oxide, a zinc oxide, a zirconium oxide, a titanium aluminum oxide, a silicon aluminum oxide, or a combination thereof. The metal oxide may comprise titanium dioxide.

The metal oxide layer 134 may have a thickness of less than 20 nm, such as less than 10 nm. The metal oxide layer 134 may have a thickness of from 1-20 nm, such as from 2-15 nm or from 5-10 nm.

The protective layer 122 (including both the metal oxynitride layer 132 and the metal oxide layer 134) may have a thickness of less than 70 nm, such as less than 50 nm. The second layer 108 may have a thickness of from 10-70 nm, such as from 15-60 nm, or from 20-50 nm. Alternatively, the second layer 108 may have a thickness of 70-100 nm, such as from 72-97 nm, or from 80-95 nm.

The sum of the thickness of the second layer 108 and the optional protective layer 122 (layers over the functional layer 106) may have a thickness of from 70-100 nm, such as from 72-97 nm, or from 80-95 nm, which may exhibit improved antireflective properties. The sum of the thickness of the second layer 108 and the optional protective layer 122 (layers over the functional layer 106) may have a thickness of up to 100 nm or up to 95 nm.

As shown in FIGS. 10 and 1D, the protective layer 122 may be the outermost layer on the coated article 120, 130, such that no coating layer is arranged thereover.

Referring to FIG. 1D, the coated article 130 may consist essentially of or consist of: the first layer 104 arranged over the article 102, the first layer 104 comprising: an underlayer 112 arranged over the article 102, the underlayer 112 comprising at least one of zinc oxide, tin oxide, zinc-tin oxide, zinc stannate, silicon nitride, silicon aluminum nitride, or a combination thereof; and an overlayer 114 arranged over the underlayer 112, the overlayer 114 comprising a silicon oxide; the functional layer 106 arranged over the first layer 104; the second layer 108 arranged over the functional layer 106, the second layer 108 comprising a silicon oxide; and the protective layer 122 arranged over the second layer 108, the protective layer 122 comprising: a metal oxynitride layer 132 arranged over the second layer 108; and a metal oxide layer 134 arranged over the metal oxynitride layer 132, the metal oxide layer 134 comprising at least one of a titanium oxide, a zinc oxide, a zirconium oxide, a titanium aluminum oxide, silicon aluminum oxide, or a combination thereof.

Referring to FIG. 1D, the coated article 130 may have a layered structure in which the first layer 104 is arranged directly over the article 102, the first layer 104 comprising: an underlayer 112 arranged directly over the article 102, the underlayer 112 comprising at least one of zinc oxide, tin oxide, zinc-tin oxide, zinc stannate, silicon nitride, silicon aluminum nitride, or a combination thereof; and an overlayer 114 arranged directly over the underlayer 112, the overlayer 114 comprising a silicon oxide; the functional layer 106 arranged directly over the first layer 104; the second layer 108 arranged directly over the functional layer 106, the second layer 108 comprising a silicon oxide; and the protective layer 122 arranged directly over the second layer 108, the protective layer 122 comprising: a metal oxynitride layer 132 arranged directly over the second layer 108; and a metal oxide layer 134 arranged directly over the metal oxynitride layer 132, the metal oxide layer 134 comprising at least one of a titanium oxide, a zinc oxide, a zirconium oxide, a titanium aluminum oxide, silicon aluminum oxide, or a combination thereof.

Tables 1-4 below provide non-limiting examples of useful coated articles according to the present disclosure, including thickness and preferred thickness of the various layers. The order in which the layers are arranged over the substrate are reported from top to bottom of the table.

The following is a non-limiting embodiment of a coated article.

TABLE 1

| | | Preferred Thickness |
|---|---|---|
| Material | Thickness Range | Range |
| Substrate | — | — |
| Underlayer | 10-30 nm | 10-20 nm |
| (First Layer) | | |
| Overlayer | 20-50 nm | 20-40 nm |
| (First Layer) | | |
| Functional | 55-110 nm (vehicle) | 70-90 nm (vehicle) |
| Layer | 100-160 nm | 120-140 nm |
| | (architectural) | (architectural) |
| Second Layer | 10-70 nm | 30-55 nm |
| | 70-100 nm (if | 80-95 nm (if |
| | antireflective | antireflective |
| | properties desired) | properties desired) |

The following is a non-limiting embodiment of a coated article.

TABLE 2

| | | Preferred Thickness |
|---|---|---|
| Material | Thickness Range | Range |
| Substrate | — | — |
| Underlayer (First | 10-30 nm | 10-20 nm |
| Layer) | | |
| Overlayer (First | 20-50 nm | 20-40 nm |
| Layer) | | |
| Functional Layer | 55-110 nm (vehicle) | 70-90 nm (vehicle) |
| | 100-160 nm | 120-140 nm |
| | (architectural) | (architectural) |
| Second Layer | 10-70 nm | 30-55 nm |
| | 65-100 nm (if | 80-95 nm (if |
| | antireflective | antireflective properties |
| | properties desired) | desired) |
| Metal Oxynitride | 10-50 nm | 20-40 nm |
| Layer (Protective | | |
| Layer) | | |
| Metal Oxide Layer | 1-20 nm | 5-10 nm |
| (Protective Layer) | | |

The following is a non-limiting embodiment of a coated article.

TABLE 3

| | | Preferred Thickness |
|---|---|---|
| Material | Thickness Range | Range |
| Substrate | — | — |
| ZnSnO | 10-30 nm | 10-20 nm |
| SiAlO | 20-50 nm | 20-40 nm |
| ITO | 55-110 nm (vehicle) | 70-90 nm (vehicle) |
| | 100-160 nm | 120-140 nm |
| | (architectural) | (architectural) |
| SiAlO | 10-70 nm | 30-55 nm |
| | 65-100 nm (if | 80-95 nm (if |
| | antireflective | antireflective properties |
| | properties desired) | desired) |

The following is a non-limiting embodiment of a coated article.

TABLE 4

| | | Preferred Thickness |
|---|---|---|
| Material | Thickness Range | Range |
| Substrate | — | — |
| ZnSnO | 10-30 nm | 10-20 nm |
| SiAlO | 20-50 nm | 20-40 nm |
| ITO | 55-110 nm (vehicle) | 70-90 nm (vehicle) |
| | 100-160 nm | 120-140 nm |
| | (architectural) | (architectural) |
| SiAlO | 10-70 nm | 30-55 nm |
| | 65-100 nm (if | 80-95 nm (if |
| | antireflective | antireflective properties |
| | properties desired) | desired) |
| SiAlON | 10-50 nm | 20-40 nm |
| TiO₂ | 1-20 nm | 5-10 nm |

Any of the layers described herein can be deposited over the substrate or another layer by any useful method, such as, but not limited to, chemical vapor deposition (CVD) and/or physical vapor deposition (PVD) methods. Examples of CVD processes include spray pyrolysis. Examples of PVD processes include electron beam evaporation and vacuum sputtering (such as magnetron sputter vapor deposition (MSVD)). Other coating methods could also be used, such as, but not limited to, sol-gel deposition. In one non-limiting embodiment, a coating layer is deposited by MSVD. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328,768; and 5,492,750.

Referring to FIGS. 2 and 3, coated articles 200, 300 are shown according to some non-limiting embodiments. Components bearing element numbers having the same last two digits may have the same or similar characteristics. For example, components 102, 202, 302 all refer to an article, which bear the final two digits “02” and may have the same or similar characteristics as each other.

Referring to FIG. 2, a coated article 200 including a multi-layer coating stack applied over a transparency mounted in a vehicle body is shown. In FIG. 2, the coated article 200 includes an article 202 (also referred to herein as a transparency or ply) having a multi-layer coating stack 236 thereover. The article 202 may be a transparency in a vehicle. The type of vehicle is not particularly limited and may include, for example, an automobile or airplane. The transparency 202 may be a vehicle window, such as a front or rear windshield, a driver or passenger door window, a sunroof or moonroof, or the like of a vehicle.

The multi-layer coating stack 236 may comprise, consist essentially of, or consist of any of the coating stacks described in this disclosure.

The transparency 202 coated by the multi-layer coating stack 236 may be mounted in a vehicle body 238. Non-limiting examples of the vehicle body 238 include: an automobile roof in the case of a sunroof, an automobile door or frame in the case of an automobile window, or a fuselage of an airplane. The transparency 202 may be affixed to a mechanism by which the transparency, such as a car window or sunroof, can be opened and closed, as is broadly known in the vehicular arts.

With continued reference to FIG. 2, the transparency 202 may have a single ply, although multi-ply transparencies are also within the scope of the disclosure. The transparency 202 may comprise a first major surface 240 (No. 1 surface) and an opposed second major surface 242 (No. 2 surface). In the illustrated non-limiting embodiment, the first major surface 240 faces the vehicle's exterior, and thus is an outer major surface, and the second major surface 242 faces the interior of the vehicle. The multi-layer coating stack 236 may be formed over at least a portion of the transparency 202. In some preferred embodiments, the multi-layer layer coating stack 236 may be arranged over the second major surface 242 (e.g., an inside surface) of the transparency 202. The multi-layer layer coating stack 236 may be arranged over an interior-most surface of the transparency 202.

Referring to FIG. 3, a coated article 300 including a multi-layer coating stack applied over a transparency in an insulating glass unit mounted in an architectural structure is shown. In FIG. 3, the coated article 300 includes articles 302a, 302b (also referred to herein as a transparencies or plies) having a multi-layer coating stack 336 over at least one surface of the articles 302a, 302b. The transparency 302a, 302b may be a transparency in an insulating glass unit (IGU) mounted for an architectural structure. The type of architectural structure is not particularly limited and may include, for example, a building. The insulating glass unit may comprise a window or skylight, for example. However, it is to be understood that the coated articles 300 described herein are not limited to use with such architectural transparencies but could be practiced with transparencies in any desired field, such as, but not limited to, laminated or non-laminated residential and/or commercial windows, insulating glass units, and/or transparencies for land, air, space, above water and underwater vehicles.

The multi-layer coating stack 336 may comprise, consist essentially of, or consist of any of the coating stacks described in this disclosure.

The transparency 302a, 302b coated by the multi-layer coating stack 336 may be mounted in an architectural structure 344. Non-limiting examples of the architectural structure 344 include an opening for a window or skylight in a commercial or residential building. The transparency 302a, 302b may be affixed to a mechanism by which the transparency, such as the window or skylight, can be opened and closed, as is broadly known in the art for architectural transparencies.

With continued reference to FIG. 3, the transparency 302a, 302b may have two plies, such as the first and second plies 302a, 302b as shown. However, further plies may be included in the transparency, such as a three or four ply transparency. Alternatively, the transparency may have a single ply.

In broad practice, the plies 302a, 302b can be of the same or different materials. The plies 302a, 302b can each comprise, for example, clear float glass or can be tinted or colored glass or one ply 302a, 302b can be clear glass and the other ply 302a, 302b colored glass. Although not limiting, examples of glass suitable for the first ply 302a and/or second ply 302b are described in U.S. Pat. Nos. 4,746,347; 4,792,536; 5,030,593; 5,030,594; 5,240,886; 5,385,872; and 5,393,593.

The exemplary transparency 302a, 302b of FIG. 3 is in the form of an insulating glass unit and includes a first ply 302a with a first major surface 340 (No. 1 surface) and an opposed second major surface 342 (No. 2 surface). In the illustrated non-limiting embodiment, the first major surface 340 faces the building exterior, i.e., is an outer major surface exposed to an outdoor side of the architectural structure, and the second major surface 342 faces the interior of the building. The second ply 302b has an inner (third) major surface 348 (No. 3 surface) and an outer (fourth) major surface 350 (No. 4 surface) and is spaced from the first ply 302a. The fourth major surface 350 is the surface exposed to an indoor side of the architectural structure. This numbering of the ply surfaces is in keeping with conventional practice in the fenestration art. The first and second plies 302a, 302b can be connected in any suitable manner, such as by being adhesively bonded to a conventional spacer frame. A gap 346 may be formed between the two plies 302a, 302b. The gap 346 may be defined between the second and third major surfaces 342, 348. The gap 346 can be filled with a selected atmosphere, such as air, or a non-reactive gas such as argon or krypton gas. The multi-layer coating stack 336 may be formed over at least a portion of one of the plies 302a, 302b. In some preferred embodiments, the multi-layer coating stack 336 is arranged over the fourth major surface 350 (e.g., an inside surface). The multi-layer layer coating stack 336 may be arranged over an interior-most surface of the transparencies 302a, 302b. Examples of insulating glass units are found, for example, in U.S. Pat. Nos. 4,193,236; 4,464,874; 5,088,258; and 5,106,663.

The multi-layer coating stacks described in this disclosure and applied over articles (e.g., transparencies) may function as a solar control coating. As used herein, the term “solar control coating” refers to a coating comprised of one or more layers or films that affect the solar properties of the coated article, such as, but not limited to, the amount of solar radiation, for example, visible, infrared, or ultraviolet radiation, reflected from, absorbed by, or passing through the coated article; shading coefficient; emissivity, etc. The solar control coating can block, absorb, or filter selected portions of the solar spectrum, such as, but not limited to, the IR, UV, and/or visible spectrums, or portions thereof.

The following numbered clauses are illustrative of various aspects of the disclosure:

Clause 1: An article coated by a multi-layer coating stack, comprising: the article; and the multi-layer coating stack comprising: a first layer comprising a metal oxide or a metal nitride arranged over the article; a functional layer comprising indium doped tin oxide arranged over the first layer; and a second layer comprising a silicon oxide arranged over the functional layer.

Clause 2: The coated article of clause 1, wherein the silicon oxide of the second layer comprises a silicon aluminum oxide.

Clause 3: The coated article of clause 1 or 2, wherein the first layer comprises: an underlayer arranged over the article, the underlayer comprising at least one of zinc oxide, tin oxide, zinc-tin oxide, zinc stannate, silicon nitride, silicon aluminum nitride; and an overlayer arranged over the underlayer, the overlayer comprising a silicon oxide.

Clause 4: The coated article of any of clauses 1-3, consisting essentially of or consisting of: the first layer arranged over the article, the first layer comprising: an underlayer arranged over the article, the underlayer comprising at least one of zinc oxide, tin oxide, zinc-tin oxide, zinc stannate, silicon nitride, or silicon aluminum nitride; and an overlayer arranged over the underlayer, the overlayer comprising a silicon oxide; the functional layer arranged over the first layer; and the second layer arranged over the functional layer, the second layer comprising a silicon oxide.

Clause 5: The coated article of any of clauses 1-4, wherein: the first layer is arranged directly over the article, the first layer comprising: an underlayer arranged directly over the article, the underlayer comprising at least one of zinc oxide, tin oxide, zinc-tin oxide, zinc stannate, silicon nitride, or silicon aluminum nitride; and an overlayer arranged directly over the underlayer, the overlayer comprising a silicon oxide; the functional layer arranged directly over the first layer; and the second layer arranged directly over the functional layer, the second layer comprising a silicon oxide.

Clause 6: The coated article of any of clauses 1-5, further comprising a protective layer arranged over the second layer.

Clause 7: The coated article of clause 6, wherein the protective layer comprises a metal oxynitride layer arranged over the second layer and a metal oxide layer arranged over the metal oxynitride layer, the metal oxide layer comprising at least one of a titanium oxide, a zinc oxide, a zirconium oxide, a titanium aluminum oxide, or silicon aluminum oxide.

Clause 8: The coated article of clause 6 or 7, consisting essentially of or consisting of: the first layer arranged over the article, the first layer comprising: an underlayer arranged over the article, the underlayer comprising at least one of zinc oxide, tin oxide, zinc-tin oxide, zinc stannate, silicon nitride, or silicon aluminum nitride; and an overlayer arranged over the underlayer, the overlayer comprising a silicon oxide; the functional layer arranged over the first layer; the second layer arranged over the functional layer, the second layer comprising a silicon oxide; and the protective layer arranged over the second layer, the protective layer comprising: a metal oxynitride layer arranged over the second layer; and a metal oxide layer arranged over the metal oxynitride layer, the metal oxide layer comprising at least one of a titanium oxide, a zinc oxide, a zirconium oxide, a titanium aluminum oxide, or silicon aluminum oxide.

Clause 9: The coated article of any of clauses 6-8, wherein: the first layer is arranged directly over the article, the first layer comprising: an underlayer arranged directly over the article, the underlayer comprising at least one of zinc oxide, tin oxide, zinc-tin oxide, zinc stannate, silicon nitride, or silicon aluminum nitride; and an overlayer arranged directly over the underlayer, the overlayer comprising a silicon oxide; the functional layer arranged directly over the first layer; the second layer arranged directly over the functional layer, the second layer comprising a silicon oxide; and the protective layer arranged directly over the second layer, the protective layer comprising: a metal oxynitride layer arranged directly over the second layer; and a metal oxide layer arranged directly over the metal oxynitride layer, the metal oxide layer comprising at least one of a titanium oxide, a zinc oxide, a zirconium oxide, a titanium aluminum oxide, or silicon aluminum oxide.

Clause 10: The coated article of any of clauses 1-9, wherein the article comprises glass or plastic.

Clause 11: The coated article of any of clauses 1-10, wherein the functional layer has a thickness of less than 160 nm.

Clause 12: The coated article of any of clauses 1-11, wherein the second layer is substantially free of alumina and a silicon aluminum oxynitride.

Clause 13: The coated article of any of clauses 1-12, wherein the second layer and/or the protective layer has a thickness of less than 70 nm.

Clause 14: The coated article of any of clauses 1-13, wherein the second layer is the outermost layer.

Clause 15: The coated article of any of clauses 6-13, wherein the protective layer is the outermost layer.

Clause 16: The coated article of any of clauses 1-15, wherein the functional layer is substantially free of a silver-containing compound.

Clause 17: The coated article of any of clauses 1-16, mounted in a body of a vehicle or an insulating glass unit.

Clause 18: The coated article of any of clauses 6-17, wherein the second layer, the protective layer, and/or the combination thereof has a thickness from 70-100 nm, preferably from 72-97 nm, or most preferably from 80-95 nm.

Clause 19: A transparency comprising the coated article of any of clauses 1-18, wherein the multi-layer coating stack is arranged on a surface of the transparency.

Clause 20: The transparency of clause 19, wherein the transparency comprises a vehicle window.

Clause 21: The transparency of clause 20, wherein the multi-layer coating stack is arranged on an inside surface of the vehicle window.

Clause 22: The transparency of clause 19, wherein the transparency comprises an insulating glass unit for an architectural structure.

Clause 23: The transparency of clause 22, wherein the insulating glass unit comprises: a first transparency having a first surface and a second surface; and a second transparency having a third surface and a fourth surface, wherein a gap is defined between the second surface and the third surface, wherein the first surface is exposed to an outdoor side of the architectural structure and the fourth surface is exposed to an indoor side of the architectural structure, wherein the multi-layer coating stack is arranged on the fourth surface.

### EXAMPLES

Examples 1-5 are examples of coated articles according to the present disclosure. While the examples describe the coating stack over a single piece of glass, it is understood that this coating may be applied to laminated glass, automotive glass, insulating glass units, etc.

The coated substrates of Examples 1-5 were prepared according to Table 5, and the sheet resistance property for each coated substrate is reported therein:

TABLE 5

| | Example 1 | Example 2 | Example 3 | Example 4 | Example 5 |
|---|---|---|---|---|---|
| Substrate | Glass | Glass | Glass | Glass | Glass |
| ZnSnO | 11 nm | 12 nm | 16 nm | 18.5 nm | 15 nm |
| SiAlO | 31 nm | 24 nm | 26 nm | 27 nm | 26 nm |
| ITO | 130 nm | 130 nm | 88 nm | 88 nm | 88 nm |
| SiAlO | 52 nm | 23 nm | 50 nm | 31.5 nm | 87 nm |
| SiAlON | — | 30 nm | — | 28 nm | — |
| TiO2 | — | 5 nm | — | 5 nm | — |
| Sheet | 16.51 | 14.76 | 22.46 | 22.48 | 22.36 |
| Resistance | | | | | |
| (Ohms/sq) | | | | | |

The sheet resistance was measured using a Suragus EddyCus TF lab 2020. The measured sheet resistance of a coated substrate is known to correlate with the emissivity property of the coated substrate, such that the sheet resistance measurements for the coated substrates in Examples 1-5 indicate that they also exhibit low emissivity properties. For example 5 having the thicker second layer, the sample exhibited improved antireflective properties relative to uncoated glass.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. An article coated by a multi-layer coating stack, comprising:
the article; and
the multi-layer coating stack comprising:
a first layer comprising a metal oxide or a metal nitride arranged over the article;
a functional layer comprising indium doped tin oxide arranged over the first layer; and
a second layer comprising a silicon oxide arranged over the functional layer.

2. The coated article of claim 1, wherein the silicon oxide of the second layer comprises a silicon aluminum oxide.

3. The coated article of claim 1, wherein the first layer comprises:
an underlayer arranged over the article, the underlayer comprising at least one of zinc oxide, tin oxide, zinc-tin oxide, zinc stannate, silicon nitride, or silicon aluminum nitride; and
an overlayer arranged over the underlayer, the overlayer comprising a silicon oxide.

4. The coated article of claim 1, consisting essentially of or consisting of:
the first layer arranged over the article, the first layer comprising:
an underlayer arranged over the article, the underlayer comprising at least one of zinc oxide, tin oxide, zinc-tin oxide, zinc stannate, silicon nitride, or silicon aluminum nitride; and
an overlayer arranged over the underlayer, the overlayer comprising a silicon oxide;
the functional layer arranged over the first layer; and
the second layer arranged over the functional layer, the second layer comprising a silicon oxide.

5. The coated article of claim 1, wherein:
the first layer is arranged directly over the article, the first layer comprising:
an underlayer arranged directly over the article, the underlayer comprising at least one of zinc oxide, tin oxide, zinc-tin oxide, zinc stannate, silicon nitride, or silicon aluminum nitride; and
an overlayer arranged directly over the underlayer, the overlayer comprising a silicon oxide;
the functional layer arranged directly over the first layer; and
the second layer arranged directly over the functional layer, the second layer comprising a silicon oxide.

6. The coated article of claim 1, further comprising a protective layer arranged over the second layer.

7. The coated article of claim 6, wherein the protective layer comprises a metal oxynitride layer arranged over the second layer and a metal oxide layer arranged over the metal oxynitride layer, the metal oxide layer comprising at least one of a titanium oxide, a zinc oxide, a zirconium oxide, a titanium aluminum oxide, or silicon aluminum oxide.

8. The coated article of claim 6, consisting essentially of or consisting of:
the first layer arranged over the article, the first layer comprising:
an underlayer arranged over the article, the underlayer comprising at least one of zinc oxide, tin oxide, zinc-tin oxide, zinc stannate, silicon nitride, or silicon aluminum nitride; and
an overlayer arranged over the underlayer, the overlayer comprising a silicon oxide;
the functional layer arranged over the first layer;
the second layer arranged over the functional layer, the second layer comprising a silicon oxide; and
the protective layer arranged over the second layer, the protective layer comprising:
a metal oxynitride layer arranged over the second layer; and
a metal oxide layer arranged over the metal oxynitride layer, the metal oxide layer comprising at least one of a titanium oxide, a zinc oxide, a zirconium oxide, a titanium aluminum oxide, silicon aluminum oxide.

9. The coated article of claim 6, wherein:
the first layer is arranged directly over the article, the first layer comprising:
an underlayer arranged directly over the article, the underlayer comprising at least one of zinc oxide, tin oxide, zinc-tin oxide, zinc stannate, silicon nitride, or silicon aluminum nitride; and
an overlayer arranged directly over the underlayer, the overlayer comprising a silicon oxide;
the functional layer arranged directly over the first layer;
the second layer arranged directly over the functional layer, the second layer comprising a silicon oxide; and
the protective layer arranged directly over the second layer, the protective layer comprising:
a metal oxynitride layer arranged directly over the second layer; and
a metal oxide layer arranged directly over the metal oxynitride layer, the metal oxide layer comprising at least one of a titanium oxide, a zinc oxide, a zirconium oxide, a titanium aluminum oxide, or silicon aluminum oxide.

10. The coated article of claim 1, wherein the article comprises glass or plastic.

11. The coated article of claim 1, wherein the functional layer has a thickness of less than 160 nm.

12. The coated article of claim 1, wherein the second layer is substantially free of alumina and a silicon aluminum oxynitride.

13. The coated article of claim 6, wherein the second layer and/or the protective layer has a thickness of less than 70 nm.

14. The coated article of claim 1, wherein the second layer is the outermost layer.

15. The coated article of claim 6, wherein the protective layer is the outermost layer.

16. The coated article of claim 1, wherein the functional layer is substantially free of a silver-containing compound.

17. The coated article of claim 1, mounted in a body of a vehicle or an insulating glass unit.

18. The coated article of claim 6, wherein the second layer, the protective layer, and/or the combination thereof has a thickness from 70-100 nm.

19. A transparency comprising the coated article of claim 1, wherein the multi-layer coating stack is arranged on a surface of the transparency.

20. The transparency of claim 19, wherein the transparency comprises a vehicle window or an insulating glass unit for an architectural structure.
